(19) United States
(12) Patent Application Publication
(10) Pub. No.: US 2020/0231169 A1
(43) Pub. Date: Jul. 23, 2020

(54) METHOD AND DEVICE FOR SUPPORTING THE DRIVER OF A MOTOR VEHICLE

(71) Applicant: German Auto Labs GAL GmbH, Berlin (DE)

(72) Inventors: Holger G. WEISS, Berlin (DE); Patrick WEISSERT, Berlin (DE); Rémi BIGOT, Berlin (DE); Dariusz SIEDLECKI, Berlin (DE); Felix PIELA, Berlin (DE)

(21) Appl. No.: 16/487,771

(22) PCT Filed: Feb. 20, 2018
(86) PCT No.: PCT/EP2018/054163

§ 371 Date: Aug. 21, 2019

(30) Foreign Application Priority Data
Feb. 20, 2017 (DE) 10 2017 103 409.9
Feb. 27, 2017 (DE) 10 2017 104 068.4
Mar. 6, 2017 (DE) 10 2017 104 661.5

(51) Int. Cl. B60W 50/14; G06F 3/16; B60K 35/00; G01C 21/36

(52) U.S. Cl. CPC B60W 50/14; G06F 3/167; B60W 2050/146; G01C 21/3661; G01C 21/3608; B60K 35/00

(57) ABSTRACT

The invention relates to a method and a device for supporting the driver of a motor vehicle. A device which can be arranged in the motor vehicle or is fitted in the motor vehicle is connected to the smartphone of the driver or passenger, and data from the smartphone and additional received data is processed and transmitted to the driver acoustically and/or visually in a prepared manner according to specified criteria. The device according to the invention has a display (3), a speech input unit (4a), and a gesture sensor (8).

The invention relates to a method and a device for supporting the driver of a motor vehicle, and can be applied for use in motor vehicles, either firmly fitted in the motor vehicle or in the form of an integrated device or a retrofittable auxiliary device which can be arranged in the field of vision of the driver.

Motor vehicles within the scope of this invention are private cars and motor homes, motorcycles, buses, commercial vehicles, construction vehicles such as excavators and cranes, towing vehicles for agriculture and forestry, and agricultural machinery such as tractors and combine harvesters, special utility vehicles for the fire department and street cleaning.

Driver-assistance systems are already known and used in new development of motor vehicles.

A compact heads-up display system with which different communication data are processed and output to the driver are known from US 2016/0025973 A1.

The object of the present invention is to provide a method and a device which make possible an effective processing of the most varied input and received data, and realize situation-dependent information of the driver, wherein it is intended for the device to be capable of being produced simply and inexpensively, and to be easy for the driver to operate, while providing little distraction.

This object is achieved by the features in claims 1 and 8. Advantageous embodiments of the invention are contained in the dependent claims. By applying the invention, thus using the device or auxiliary device with the product name CHRIS®, an intelligent digital virtual passenger is realized which, depending on different situations, supplies navigation data, music, messages, e-mails or traffic information to the driver, wherein the driver can blindly operate the device or auxiliary device, without making eye contact with the device or auxiliary device, and without touching the smartphone.

The device or auxiliary device can also be connected to the internet via the connection to the smartphone, in order for example to process weather information, navigation information etc. The connection between the auxiliary device and the smartphone takes place preferably via Bluetooth.

A particular advantage of the device or auxiliary device is that the driver can blindly and contactlessly use functions of the smartphone via the device or auxiliary device, i.e. without being in eye contact with the device or auxiliary device. Smartphone use in motor vehicles is a great and increasing problem in road traffic. Interacting with the smartphone or a modern touch infotainment system requires the driver to have eye contact with the device during use, as the user interface cannot be operated blindly. While making eye contact, the driver cannot have his eyes on the road, which turns any interaction with the smartphone or a touch infotainment system into an accident risk. The device makes blind and contactless (“no touch”) use of smartphone and car functions via speech and or gesture interaction possible, and thus reduces the potential for distraction, and increases road safety as sight and attention can remain on the road scene.

A particular advantage of the invention consists of the processing and execution of essential functions of the assistant, such as for example language processing and dialog management, as well as processing received data and smartphone data, taking place on the smartphone, and thus a powerful and up-to-date software and hardware platform for executing these functions can be guaranteed cost-effectively, independently of the vehicle and the device. This method also makes it possible that, in supporting the driver, data from his smartphone or the smartphones of passengers are used by a device which can be arranged or fitted in the motor vehicle being connected to the smartphone of the driver or passenger, and data from the smartphone as well as further received data being processed and transmitted to the driver in acoustic and/or visual form, having been prepared according to predetermined criteria.

These smartphone data can be telephone numbers and/or contact data and/or address data and/or incoming e-mails or messages and/or internet data and/or SMS messages and/or MMS messages and/or audio files and/or MP3 audio files and/or audio playlists and/or map data and/or navigation details and/or personal data of the driver or passenger.

Smartphone data are read out via individual modules or agents via interfaces provided by the smartphone. In this way, the connection to telephone functions of the smartphone is made possible via the telephony agent, the connection to the address book of the smartphone is made possible via the address book agent, and so on.

Data which are not made available directly via smartphone interfaces, such as for example navigation map data, or audio playlists from third party suppliers, are tethered either via (a) cloud interfaces of the third party supplier, or (b) via software development kits (SDKs) of the respective supplier.

Preferably, map and or navigation data and/or traffic information and/or radio or TV transmissions and/or digital audio streams and/or congestion reports and/or WhatsApp messages and/or Facebook Messenger messages and/or weather data are processed as received data.

A further advantage of the invention is in the optimized selection of the data to be processed and transmitted, which takes place depending on the driving situation and/or traffic situation and/or time of day and/or weather and/or user preference and/or historical use of data by the user and/or preferences of other users and/or historical use of data by other users.

In so doing, the system can be adapted both to situations in which the driver is subjected to a high cognitive load, or which are very risky, and to situations in which the driver is cognitively underloaded and if applicable must be stimulated in order to prevent tiredness or falling asleep.

The overall system is designed to be adaptive, with the result that conclusions are drawn for future data processing and data output from the frequency, as well as type of the data to be processed and transmitted. The data to be processed and transmitted are selected according to the method steps listed below:
Recording the vehicle and traffic situation data such as speed, navigation data, traffic volume, road geometry, road width, number of lanes, frequency of accidents, speed restrictions, general traffic reports and special situations such as construction sites.
Recording further context data such as current weather, visibility, temperature, time of day, light conditions,
Retrieving user preferences and historical usage behavior of the user,
Determining the complexity of the traffic situation according to a complexity index of traffic data and context data,
Determining the priority of transmission and provision of data from preferences of the user, historical usage behavior of the user, preferences of other users and of historical user behavior of other users,
Correlating the recorded data with predetermined program sequence patterns,
Outputting or temporary or permanent suppression of such prioritized data for use by the driver or passenger.

In the embodiment as device or auxiliary device, the device contains as standard an internal power supply, microphone, digital processor, display, gesture sensor(s), a loudspeaker and wireless communication units. The gesture sensors are preferably designed as LED-based IR sensors.

The device for supporting the driver can be produced simply and at reasonable cost, wherein the device has a display and a speech input unit. The device can be coupled to additional input units, such as for example the input devices in a multifunction steering wheel or gesture sensors. The device preferably also has an electronic circuit arranged on a printed circuit board, with a data storage device and a data processing device. Bluetooth components are arranged for internal data transmission.

In a special embodiment, the device is designed as an auxiliary device with a display arranged in a housing, and with a speech input unit and a speech output unit.

In operating state, the device can be connected to the audio system of the motor vehicle or elements of the on-board electronics wirelessly or also wired.

In motor vehicles which do not have Bluetooth function, the connection takes place via FM transmitter/receiver.

The auxiliary device preferably has a circular cross-section and comprises the constituents disk, ring, printed circuit board, battery, loudspeaker, housing magnet, rear housing part and main magnet. In the design as auxiliary device, the housing has a fixing device for fixing to the dashboard or windshield of the motor vehicle. The fixing device and the housing can be connected to one another in detachable manner.

An advantage of the invention consists of it being possible to attach the device to the holder easily and quickly, and detach it easily and quickly therefrom, making possible different installation positions by arranging fixing regions both on the device and also on the holder, wherein the fixing region of the rear of the device has at least one holder magnet and two fixing sectors arranged in mirror inversion, which sectors are provided with electrical contacts arranged in mirror inversion, and the fixing region on the holder has at least one holder magnet and a fixing sector with electrical contacts, wherein, in assembled state, the holder magnets and the electrical contacts of the fixing sector are in contact with the electrical contacts of the two different fixing sectors such that, depending on the contact to the respective fixing sector, a positioning of the device rotated about 180° is realized.

In addition to the simple manipulation a further advantage of the invention is the high stability of the connection which comes as a result of the fixing sectors at the device being semicircular recesses and the fixing sectors at the holder being semicircular bars, wherein the recesses and the bars, in assembled state, correspond to one another.

An additional advantage of the invention consists of the secure mechanical connection, with the holder magnets guaranteeing mechanical fixing both to the device and also to the holder. Electrical contact between the device and the holder is realized by the electrical contacts.

The electrical power supply, a data exchange and the transmission of radio signals and if appropriate further received signals is realized via the electrical contact between the electrical contacts at the device and the electrical contacts at the holder.

It has proved expedient to arrange at least one holder magnet and at least two, but preferably five, electrical contacts in each of the fixing sectors. For secure fixing to a smooth surface, the holder can be provided with a suction cup and have one or more USB terminals.

An optimization of the speech recognition is achieved by the device having a rear housing part and a ring connected thereto with openings in its front region, wherein the display and a printed circuit board with microphones is arranged within the ring.

According to this embodiment, the device has in principle a three-part structure of the overall housing with a central ring as its base. A rear housing part is attached to the rear of the ring, and the circular display is arranged to the front. A printed circuit board is mounted inside the ring, behind the display and in front of the rear housing part. Thus, with the in principle three-part structure it is possible to produce a very stable, elegant and cost-effective housing.

Space for attaching microphones directed to the loudspeaker or driver is limited in devices with a circular cross-section and a likewise circular display.

According to this embodiment, the display is mounted in the ring with a circular cross-section, and a joint, which passes around the display, is incorporated right next to the display, in the front region of the ring. In turn, openings which direct the sound backwards to the microphones and are invisible to the user or driver, are incorporated in this joint. The microphones are arranged on the printed circuit board arranged on the rear of the ring, preferably vis-a-vis the openings. The openings form audio channels through which the sound reaches the microphones.

The invention will be explained in more detail below using the embodiments represented at least partially in the Figures.

There are shown in:

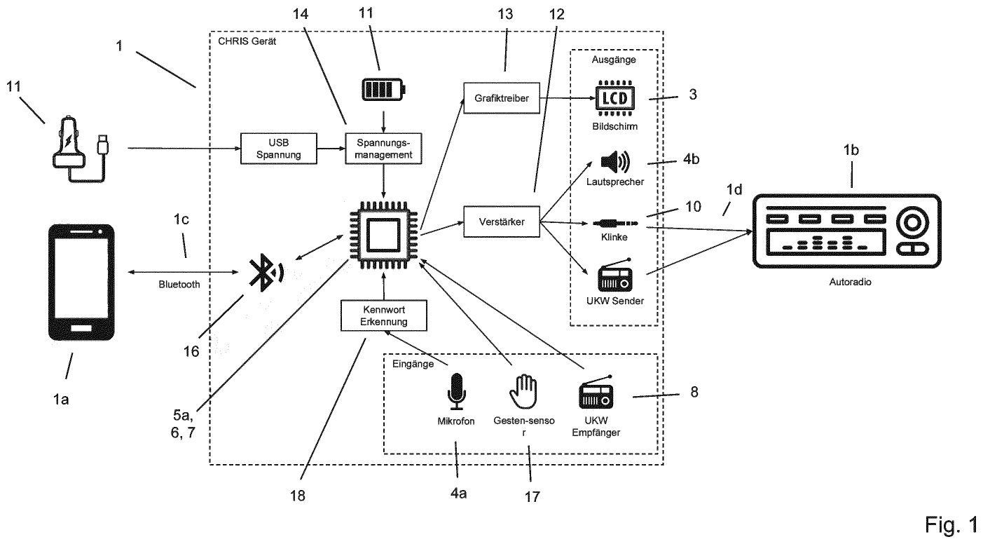

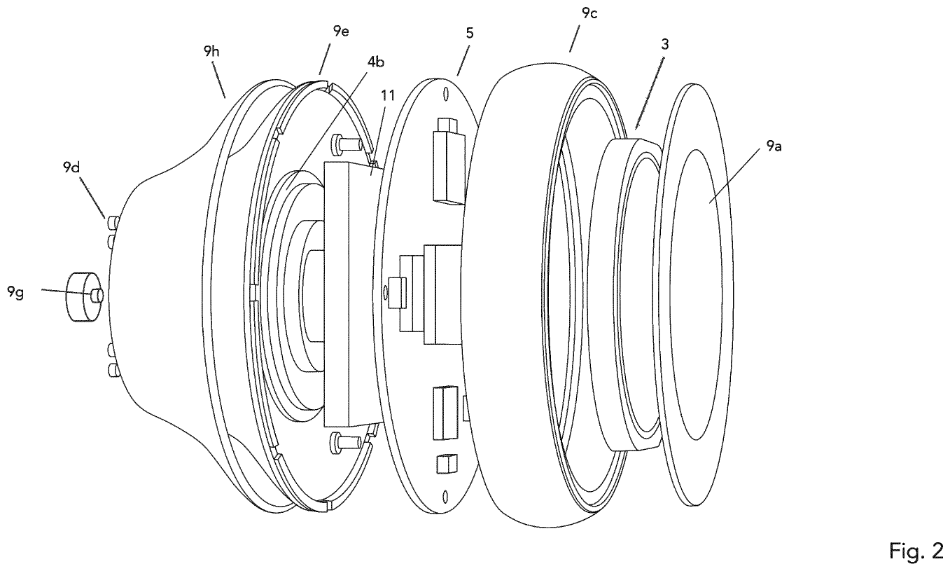

FIG. 1 an overview of the system components

FIG. 2 an exploded view of the device components of an auxiliary device

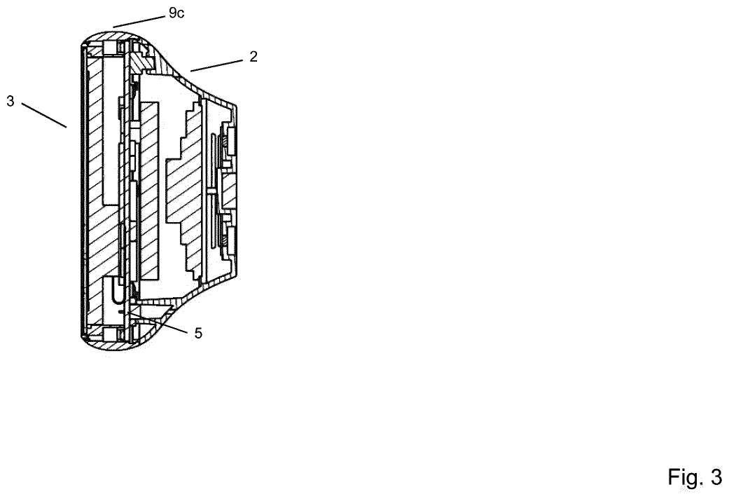

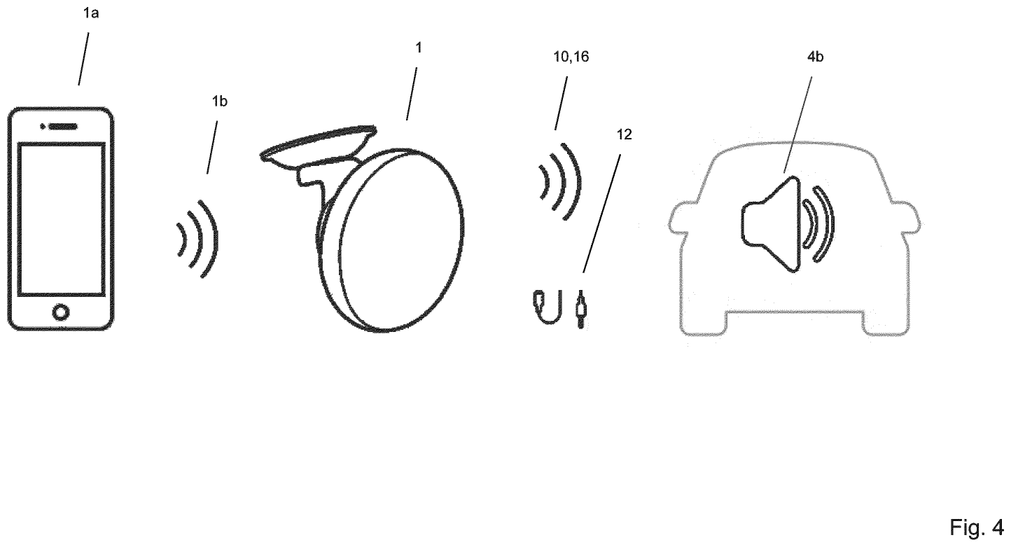

FIG. 3 a sectional view with device components of an auxiliary device

FIG. 4 a representation of the communication connections

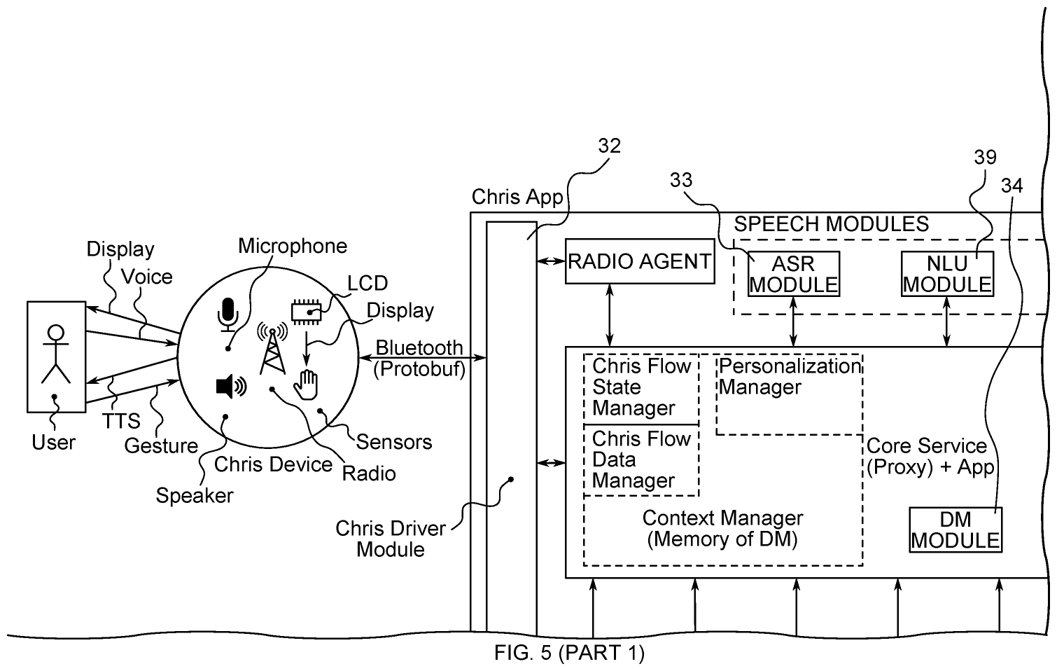

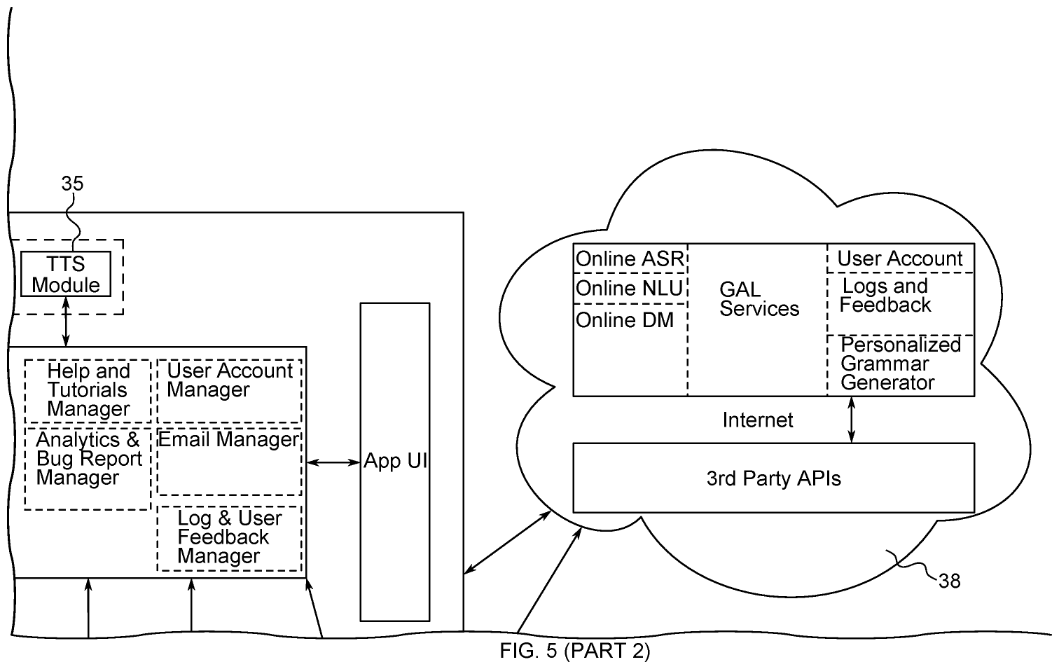

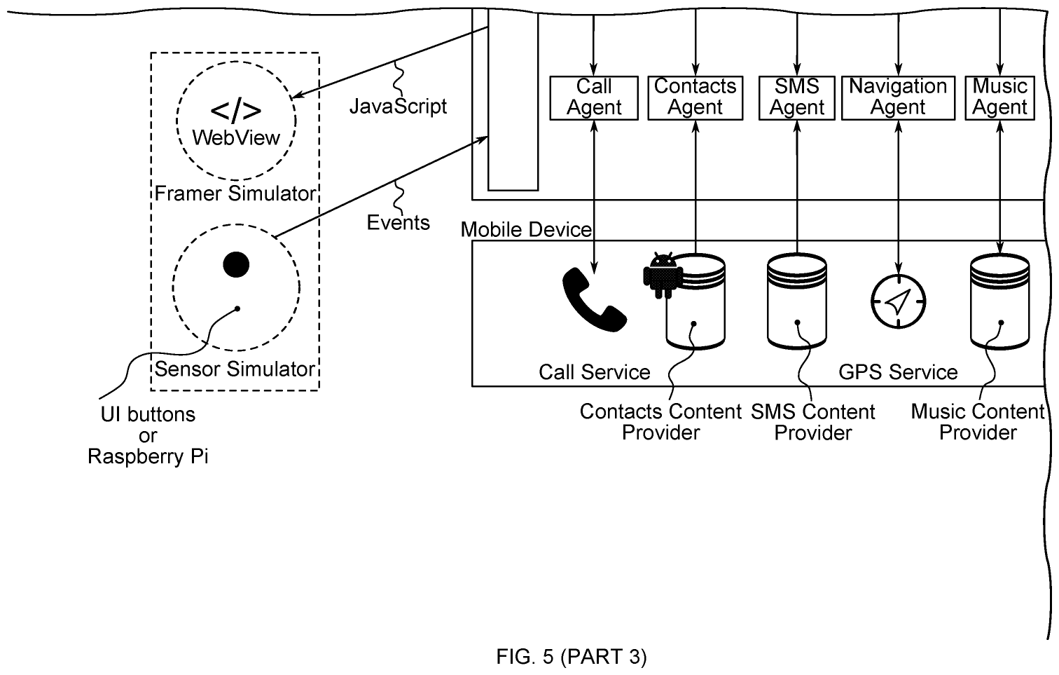

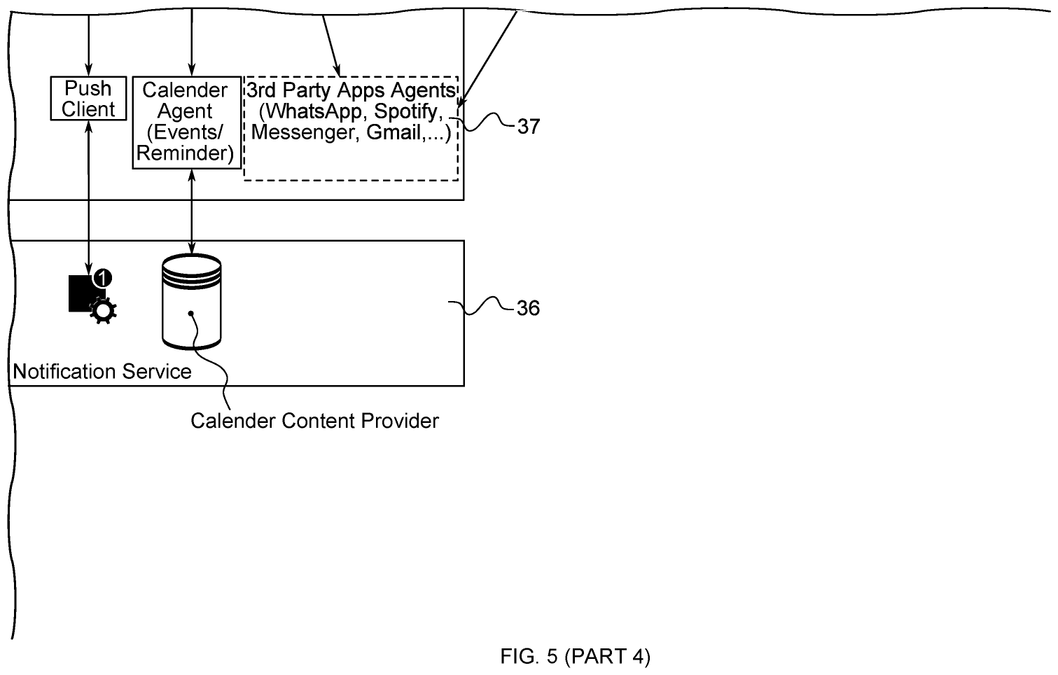

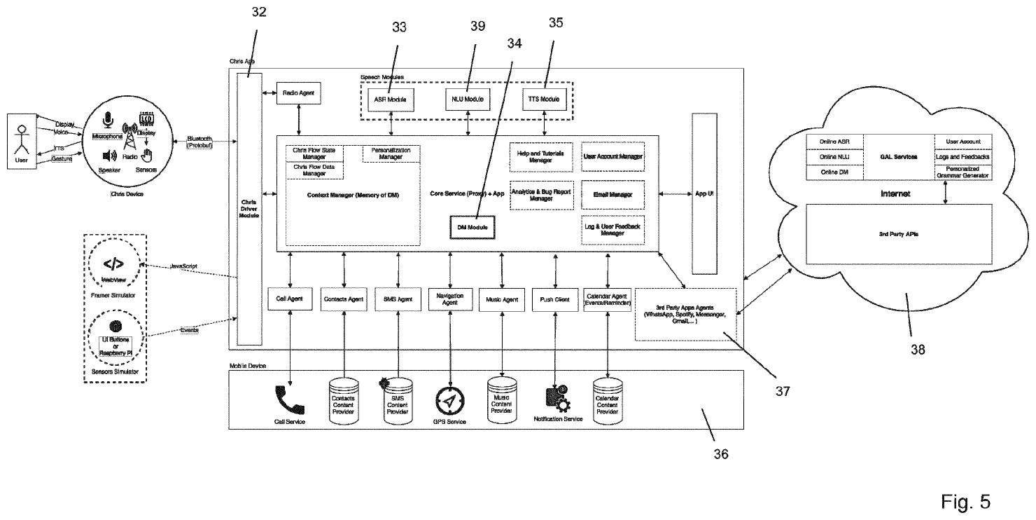

FIG. 5 an overview of the whole system

FIG. 6 the rear of the device according to the invention, with fixing region in top view and lateral top view

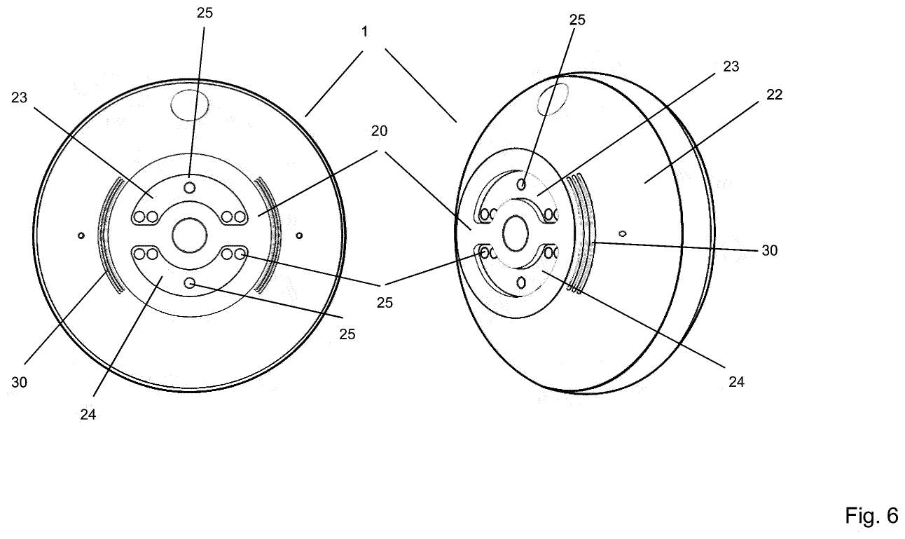

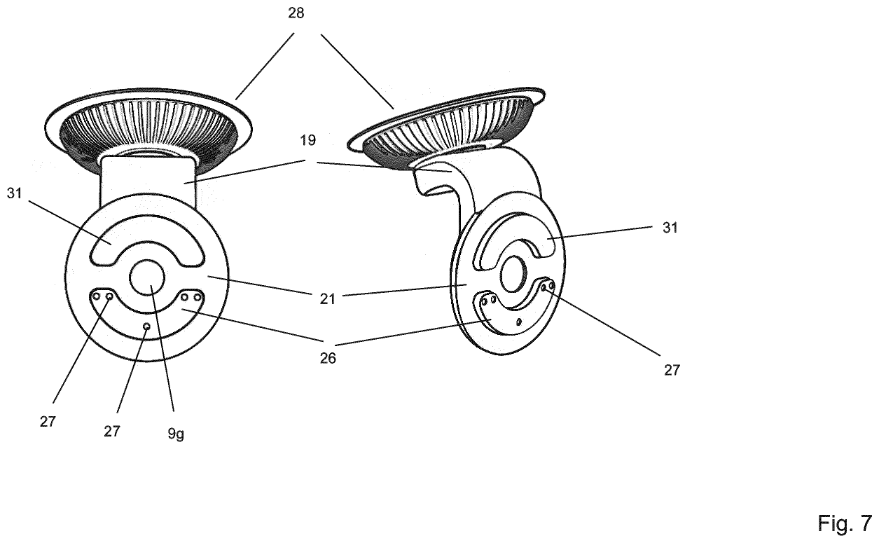

FIG. 7 the fixing region of the holder in top view and lateral top view

FIG. 8 the device mounted on the holder

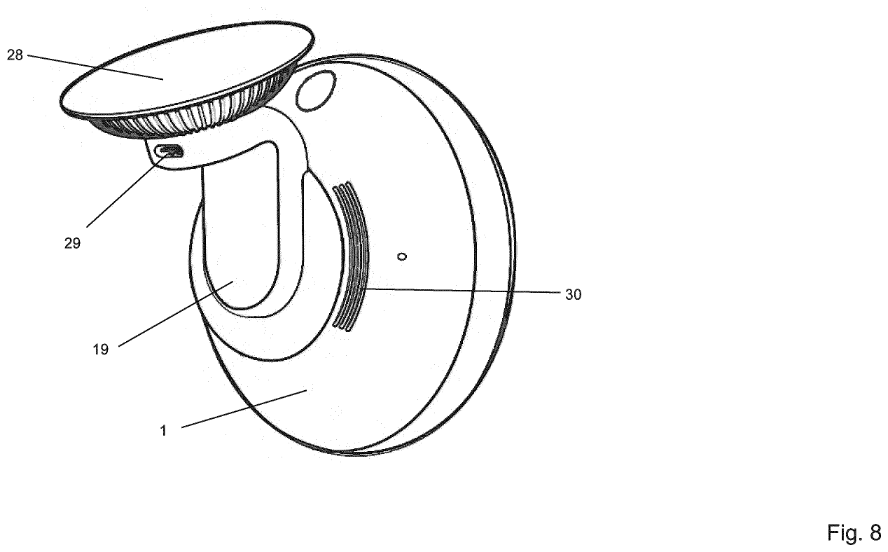

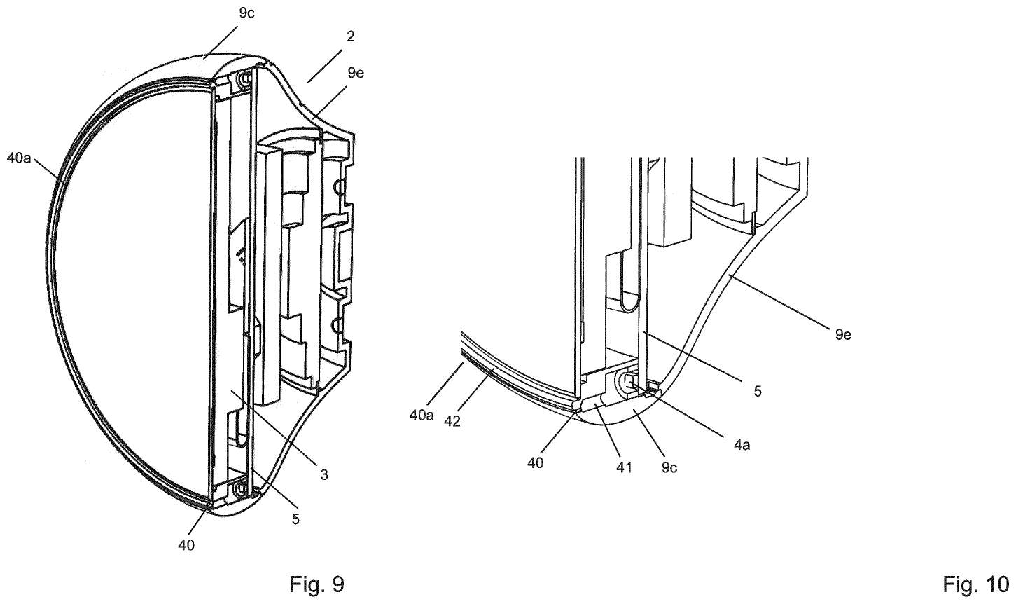

FIG. 9 a sectional view of the principle structure of the device

FIG. 10 a detailed view of the arrangement of openings and microphones

FIG. 11 a front view of the device with the openings in the ring

Device Structure

As shown in FIG. 1, the device 1 according to the invention is electronically connected to a smartphone 1a of the driver or of a passenger, as well as, in the present embodiment example, to a car radio 1b, which can be designed with or without navigation system. The device 1 can also be connected to the audio system of the motor vehicle and to elements of the on-board electronics. In the present embodiment example, the electronic connection between smartphone 1a and device 1 is a Bluetooth connection 1c.

The car radio 1b can be connected to the device via a cable 1d, a Bluetooth connection or via a FM transmitter 10.

Smartphone 1a and device 1 can be connected to a USB power supply unit 15 which in the present embodiment example has two USB terminals.

Inside the housing 2, the device 1 has a printed circuit board 5 with an electronic circuit 5a with data storage unit 6 and data processing unit 7. In the present embodiment example, the electronic circuit 5a is furthermore connected to an amplifier 12 connected to a speech output unit 4b designed as a loudspeaker, a graphics driver 13, a FM receiver 17, a gesture sensor 8, an energy management group 14 connected to a power supply unit 11, the Bluetooth components 16 and a switch-off device 18 connected to a speech input unit 4a designed as a microphone, which switches between waking and sleeping states for reasons of energy conservation.

Via the Bluetooth connection 1c, when the device is in entered into operation, a data transfer, with which all essential data are transferred internally, takes place between the smartphone 1a and the device 1.

FIGS. 2 and 3 show the detailed structure of the device 1 and of the housing 2 of the device 1 designed as an auxiliary device. The disk 9a, ring 9c, printed circuit board 5, power supply unit 11 designed as a battery, loudspeaker 4b , housing magnet 9d, rear housing part 9e, main magnet 9g and textile cover 9h which can be arranged as an alternative to rear housing part 9e are essential constituents. In addition to making the device 1 more aesthetically appealing, the textile cover 9h has the advantage that the effect of strong solar radiation on the device 1 is reduced.

The disk 9a is made of glass, the ring 9c of metal, preferably aluminum, and the rear part 9e of plastic. The display 3, the printed circuit board 5 and the housing 2 are installed in the ring 9c via the rear housing part 9e, i.e. the printed circuit board 5, the housing 2 and the display 3 are installed via the ring 9c.

Due to the small dimensions of the device 1 and the part-spherical shape, the structure of the housing 2 is substantially different to square devices.

As can be seen from FIG. 3, a substantially three-part design is realized with the central ring 9c as the base, as well as the housing 2 and the display 3. The printed circuit board 5 is installed in the ring 9c.

The preferred methods of connection between smartphone 1a, device 1 and car radio 1b to the loudspeaker 4b are shown in FIG. 4. In the present embodiment example, the smartphone 1a is connected to the device 1 via Bluetooth 16. In the present embodiment example, the device 1 is connected to the car radio 1b via Bluetooth 16 or via a jack connection 1d or via VHF, i.e. FM transmitter and FM receiver.

If the device 1 is designed as an auxiliary device, it is fixed in the field of vision of the driver, preferably to the dashboard or to the windshield, by means of a holder.

Connection between Device, Smartphone and Vehicle

The device 1 or the auxiliary device connects, automatically and wirelessly, to the smartphone 1a of the driver or the smartphone 1a of a passenger (see FIG. 1, 1c) and to the audio system of the motor vehicle (FIG. 1, 1d). Naturally, an acoustic data output is also possible, directly from the auxiliary device, by means of the loudspeaker. Connection to the audio system of the motor vehicle can be wireless via Bluetooth 1c or via an installed VHF transmitter, or in wired manner to the audio system of the motor vehicle via the motor vehicle electronics or a jack connection. The connection to the smartphone 1a is via Bluetooth 1c and Bluetooth Low Energy (BLE). The following Bluetooth profiles are used:
1) Hands-free Profile (HFP) (a) for transmitting speech data from the device 1 to the smartphone 1a and from the smartphone 1a to the device 1, and (b) by making telephone calls in hands free mode via the installed loudspeaker or the connected vehicle loudspeaker.
2) Advanced Audio Distribution Profile (A2DP) for transmitting high-quality stereo audio data from the smartphone 1a to the device 1, and from the device 1 to the audio system of the vehicle, if this is connected to the device 1 via Bluetooth 1c.
3) Phonebook Access Profile (PBAP), in order to be able to access the call lists of the smartphone 1a.
4) Audio/Video Remote Control Profile (AVRCP) for transmitting commands from the motor vehicle to the device 1.

Non-auditory data, such as for example the graphic user interface, gesture control and other control signals, data which are transmitted from the device 1 to the smartphone 1a (working state, states of other applications), are transmitted via Bluetooth Low Energy (BLE).

Smartphone Application

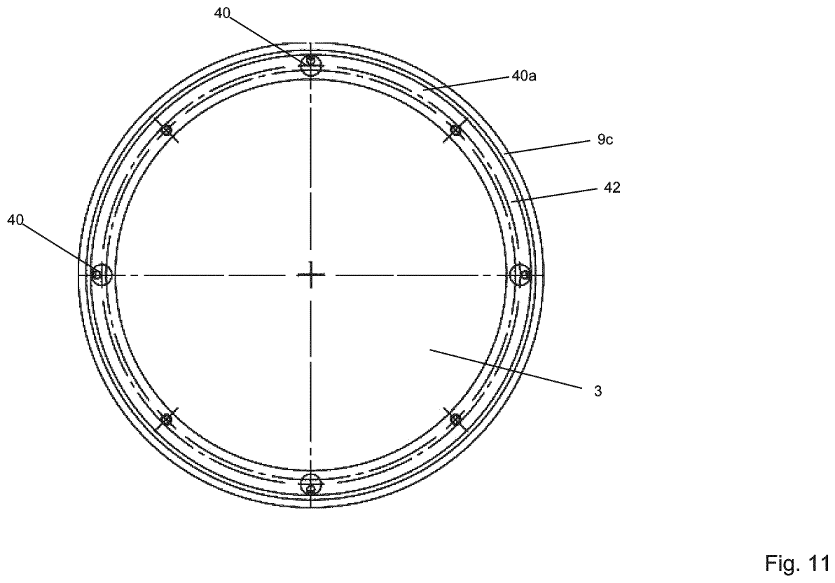

An associated smartphone application which communicates with the device 1 or auxiliary device (FIG. 5) via the Bluetooth interface 1c is located on the smartphone 1a. Communication between the device 1 and the smartphone application is controlled via the Chris driver module (FIG. 5, 32) in the smartphone application. Via this module, the smartphone application can communicate with different devices or auxiliary devices. Numerous essential processes take place in the smartphone application, above all (a) speech processing of speech signals (FIGS. 5, 33 and 39), dialog management (FIG. 5, 34) and speech output (FIG. 5, 35), (b) tethering of interfaces to smartphone functions (telephony, address book, messages, etc., FIG. 5, 36) and software modules (navigation, streaming music services, etc., FIG. 5, 37), (c) tethering and cloud-based services (messaging, logging & analytics, etc., FIG. 5, 38), (d) control and algorithms for functions such as adaptive speech output and context processing (FIG. 5, 39).

Speech Processing

The speech processing chain consists of the following constituents:
1) Speech-based activation of speech recognition (Wake Word Detection)
2) Speech recognition (Automated Speech Recognition, ASR)
3) Interpretation of speech input (Natural Language Understanding, NLU)
4) Dialog Management (DM)
5) Generating speech outputs (Natural Language Generation, NLG)
6) Speech synthesis (Text to Speech, TTS)

Speech-based activation of speech recognition takes place locally on the device 1 or the auxiliary device. Communication in the vehicle is continuously analyzed until the keyword for activating speech recognition is detected, at which point the speech data transmission from the microphone of the device 1 or auxiliary device in the speech recognition system is started in the smartphone application. Speech is recognized via a hybrid system which can carry out speech recognition both on the smartphone 1a in the smartphone application and also via the cloud interface online via an online speech recognition service. Consequently, the whole process chain of speech recognition via interpretation, dialog management, and speech synthesis and output can be carried out locally on the smartphone 1a in the smartphone application.

As a rule, the local speech recognition in the smartphone application is used, as here the recognition can take place more quickly and robustly and is also more suitable from a data protection point of view. Purely internet-based speech recognition is unsuitable for motor vehicles as these are repeatedly in areas without or with inadequate mobile phone data connection. For special applications, such as for example recognition of addresses or points of interests (POI), the local speech recognition in the smartphone application is supplemented by cloud-based speech recognition.

For the purposes of speech recognition, the microphone signal is transmitted to the smartphone 1a via the Bluetooth connection by means of the Bluetooth Handsfree Profile (HFP). To increase the recognition performance, special microphones for speech recognition are used which are independent of the microphone used for hands-free telephony, and which, via beamforming and echo cancellation, transmit a clear speech signal of the driver to the smartphone 1a and its associated smartphone application. The speech signal is transmitted from the device 1 or auxiliary device to the smartphone 1a at a bit rate optimized for the speech recognition system.

The recognition performance of the speech recognition is also increased considerably vis-a-vis other speech processing systems in motor vehicles by (a) user data such as the address book of the user, previous destinations in the navigation system or metadata of audio files being used as grammars, allowing the system for example to improve its ability to recognize names which the user has in his smartphone address book, and (b) continuously improved speech recognition models which can be imported into the smartphone application via the cloud interface.

Interpretation of speech inputs and dialog management Speech inputs are interpreted in the NLU module of the smartphone application (FIG. 5, 39), wherein the speech input in is broken down into intention and further information (for example name, title, etc.) and then transferred to the dialog management module (DM module, FIG. 5, 34). There, depending on these inputs, the next step in the system interaction is determined and output via the speech generation and speech synthesis. Speech is output again via the device 1 or auxiliary device, or via the audio system of the motor vehicle when this is connected to the device 1 or auxiliary device.

Dialog is managed by the dialog management module (DM module, FIG. 5, 34) in the smartphone application. An essential feature of this module is that the actual dialog execution, i.e. the input/response rules, are stored in a script file which can be updated regularly via the cloud interface without the smartphone application itself needing to be updated. Thus, continuously optimized dialog management can be made possible for the user.

Continuous Optimization of Speech Recognition

If approved by the user, the speech inputs are stored and transmitted to a server-based logging and analysis system via the cloud interface, at which server-based system it is indexed by keyword, semi-automatically, and then used for further analysis with the aim of optimizing speech recognition performance.

Interaction Via Gesture Control

Since specific interactions with the system via speech input either cannot be uncovered or can only be uncovered under certain circumstances, the device 1 or auxiliary device also has a gesture sensor (FIG. 1, 17). The gesture sensor recognizes the following gestures:
1) Swiping gesture from right to left (“left”)
2) Swiping gesture from left to right (“right”)
3) Swiping gesture from bottom to top (“up”)
4) Swiping gesture from top to bottom (“down”)
5) Held hand (“High 5”)
6) Moving the hand away from the device (“near”)
7) Moving the hand towards the device (“far”)

Inter alia, the following functions can be reproduced via this set of gestures:
a) Scrolling from one list entry to the next list entry, such as for example in a list of contacts, songs or messages or from one menu entry to the next menu entry (“left” gesture, context-dependent)
b) Scrolling from one list entry to the previous list entry or from one menu entry to the previous menu entry (“right” gesture, context-dependent)
c) Cancelling actions (“down” gesture, context-dependent)
d) Returning to the previous step (“down” gesture, context-dependent)
e) Selecting menu or list entry (“up” gesture or “High 5” gesture, context-dependent)
f) Going back up to the next menu (“down” gesture, context-dependent)
g) Increasing volume, for example in a telephone call or music playback (“far” gesture, context-dependent)
h) Decreasing volume (“near” gesture, context-dependent)
i) Pausing, starting or picking up music playback (“High 5” gesture, context-dependent)
j) Muting (“Mute”) sound during a telephone call (“High 5”, context-dependent)

Interaction Via Input Devices of the Vehicle

The device can recognize and use standardized commands via the Bluetooth AVCRP profile as a third input mechanism, via a Bluetooth connection 1c to the car, or to the infotainment system or car radio 1b of the car. For example, where supported by the vehicle the control keys of a multifunction steering wheel can be used in this way as input mechanism. Bluetooth AVRCP is a profile for remotely controlling audio or video devices. It supports commands such as next song (“forward”), previous song (“backward”), pause and playback, louder or softer. These are used in the following manner in the Chris assistant:
a) Scrolling from one list entry to the next list entry, such as for example in a list of contacts, songs or messages or from one menu entry to the next menu entry (“fast forward” and “forward” AVRCP command)
b) Scrolling from one list entry to the previous list entry or from one menu entry to the previous menu entry (“backward” AVRCP command)
c) Cancelling actions (“exit” AVRCP command)
d) Returning to the previous step (“exit” AVRCP command)
e) Selecting menu or list entry (“select” AVRCP command, context-dependent)
f) Going back up to the next menu (“exit” AVRCP command, context-dependent)
g) Increasing volume, for example in a telephone call or music playback (“volume up” AVRCP command)
h) Decreasing volume (“volume down” AVRCP command, context-dependent)
i) Pausing, starting or picking up music playback (“play”, “pause” and “stop” AVRCP command, context-dependent)
j) Muting (“Mute”) sound during a telephone call (“mute” AVRCP command, context-dependent)

AVRCP commands are processed by the Bluetooth connection 1c of the device 1 or auxiliary device with the vehicle identifying the device 1 or auxiliary device as the audio source which supports AVRCP commands. The AVRCP commands are received in the device 1 or auxiliary device and then converted as pure data models then further transmitted to the associated smartphone app, where they are then processed, context-dependent, according to the above diagram. In this way, input possibilities of the vehicle can be used not only for audio playback but also for control in menus and dialogs.

Redundant and Complementary Multi-Modal Interaction

A further essential feature of the “Chris” assistant is that the three input mechanisms speech input, gesture control and control via input devices of the vehicle can be carried out multimodally, in addition. Thus, for example the operation can take place in a list of entries (such as for example contacts, songs or messages) as follows:
A speech command (for example “forward”) or gesture (“left”, context-dependent) or vehicle input mechanism (“skip next”) selects the next entry on the list
A speech command (for example “back”) or gesture (“right”, context-dependent) or vehicle input mechanism (“skip back”) selects the previous entry on the list

Where expedient, as many interactions as possible are provided, depending on context, either redundantly or complementarily, in order to be able to supply the driver with the best choice of mode for his preferences for the respective situation.

Speech and Display Output

A further advantage of the invention is secure data output which takes place in the form of acoustic data output as speech output and in the form of visual data output as display representation. Depending on context, information can be provided either only as speech output (for example during an enquiry in dialog processing), only as a display (for example displaying a music album during music playback) or as combined display and speech output (for example displaying a contact and reading out the name).

Detachable Fixing of Devices to a Holder

As can be seen from FIG. 6, the device 1 has a fixing region 20 on its rear 22, said fixing region being divided into two fixing sectors 23 and 24 arranged in mirror inversion. The fixing sectors 23, 24 are arranged in a recess. The fixing sectors 23, 24 are arranged in mirror inversion and are provided with electrical contacts 25 positioned in mirror inversion. In the present embodiment example, five electrical contacts 25 are arranged in each of the two fixing sectors 23, 24. Naturally, it is also possible to arrange a greater or smaller number of electrical contacts. A magnet 9g is arranged centrally in the fixing region 20. Openings 30 for loudspeakers are located laterally adjacent to the fixing region 20.

FIG. 7 shows the design of the fixing region 21 at the holder 19. In contrast to the fixing region 20, the fixing region 21 has only one fixing sector 26 at the device 1. The fixing sector 26 is designed as a bar with a semicircular shape. In the present embodiment example, a total of five electrical contacts 27 are arranged in the fixing sector 26 which correspond to the electrical contacts 25 in the fixing sectors 23 and 24 of the device 1. A magnet 9g is arranged centrally in the fixing region 21.

A suction cup 28 for fixing the holder 19 to a smooth surface is located at the holder 19.

FIG. 8 shows the completely installed unit of device 1 and holder 19. In the assembled state, the semicircular bar of the fixing sector 26 and the blind bar 31, designed as elevations, have engaged in the fixing sectors 23, 24 designed as recesses and have established the electrical connection via the electrical contacts 25 and 27 which have been brought into contact. As the fixing sectors 23, 24 are designed symmetrically identical to the device 1, the device 1 can be rotated about 180° and then, in the opposite installation position, with the device 1 via the electrical contacts 25 and 27.

The mechanical connection is realized by the cooperation between the magnets 9d and 9g.

In the present embodiment example, a USB terminal 29 is arranged at the holder 19.

As can be seen from FIG. 9, the housing 2 has a rear housing part 9e, a ring 9c and a display 3 arranged in the ring 9c, as well as a printed circuit board 5. As can be seen, the ring 9c forms a central component of the overall housing structure. The ring 9c connects to the rear housing part 9e and receives the printed circuit board 5 and the display 3 in its internal region.

Microphone Ring

FIG. 10 shows the enlarged detailed view of the opening 40 and of a microphone 4a opposite the opening 40, connected by the sound channel 41.

A joint 42 is arranged in the front region 40a of the ring 9c, in which joint the openings 40 are located, almost invisible to the observer. Via the openings 40 in the joint 42, the sound reaches the microphone 4a, designed in the present embodiment example as a directional microphone, via the sound channel 41.

FIG. 11 shows a front view of the display 3 and the ring 9c. In its front region 40a, the ring 9c has the joint 42 in which the openings 40 are arranged. In the present embodiment example, a total of four openings 40 are arranged which are positioned opposite the microphone 4a.

The invention is not limited to the embodiment examples represented here. Instead, it is possible, by combining the means and features, to realize further embodiments without going beyond the scope of the invention.

### LIST OF REFERENCES

1 Device

1a Smartphone

1b Car radio

1c Bluetooth connection

1d AUX (jack) connection

2 Housing

3 Display

4a Microphone, speech input unit

4b Loudspeaker, speech output unit

5 Printed circuit board

5a Circuit

6 Data storage unit

7 Data processing unit

8 Gesture sensor

9a Disk

9c Ring

9d Magnet, housing magnet

9e Rear housing part

9g Magnet, main magnet

9h Textile cover

10 FM transmitter

11 Power supply unit

12 Amplifier

13 Graphics driver

14 Energy management group

15 USB power supply unit

16 Bluetooth components

17 FM receiver

18 Switch-off device

19 Holder

20 Fixing region

21 Fixing region

22 Rear

23 Fixing sector

24 Fixing sector

25 Electrical contact

26 Fixing sector

27 Electrical contact

28 Suction cup

29 USB terminal

30 Loudspeaker opening

31 Blind rail

32 Chris driver module

33 Speech processing (ASR module)

34 Dialog management (DM module)

35 Speech output (TTS module)

36 Tethering of interfaces to smartphone functions

37 Tethering of interfaces to software functions

38 Tethering of interfaces to cloud based services

39 Control and algorithms for functions such as adaptive speech output and context processing (NLU module)

40 Openings

40a Front region

41 Sound channel

42 Joint

1. A method for supporting the driver of a motor vehicle, wherein a device which can be fitted or arranged in the motor vehicle is connected to the smartphone of the driver or passenger as an assistant, and data from the smartphone as well as further received data are processed electronically according to predetermined program sequences and transmitted to the driver in acoustic or visual form, having been prepared systematically.

2. The method according to claim 1, comprising the processing and execution of functions of the assistant, such as language processing and dialog management, as well as processing received data and smartphone data, takes place on the smartphone, and thus, independently of the vehicle and the device, a powerful and up-to-date software and hardware platform for carrying out these functions is guaranteed.

3. The method according to claim 1, comprising the smartphone data are telephone numbers or contact data or address data or incoming e-mails or messages or internet data or SMS messages or MMS messages or audio files or MP3 audio files or audio playlists or map data or navigation details or personal data of the driver or passenger and the received data are navigation data or traffic information or radio or TV transmissions or digital audio streams or congestion reports or WhatsApp messages or Facebook Messenger messages or weather data.

4. The method according to claim 1, comprising the speech recognition takes place either on the smartphone in the smartphone application (local speech recognition) or via the cloud interface online via a cloud-based speech recognition service (online speech recognition) or that the speech of the user is recorded on the device via a microphone, this recording is then transmitted wirelessly to the smartphone via Bluetooth (HFP), where speech recognition takes place continuously or smartphone data are used in speech processing to improve recognition performance of the speech processing or that dialog management of the speech processing takes place locally on the smartphone, but is constantly updated via a cloud interface using a script file or that the speech processing is optimized continuously by analyzing the speech inputs which have taken place, and recognition performance is improved.

5. The method according to claim 1, comprising, in addition to the speech processing, functions of the assistant are also operated via gesture control or input devices of the vehicle, and functions of the assistant are undertaken multimodally, depending on context complementarily or redundantly.

6. The method according to claim 1, comprising the data to be processed and transmitted are selected depending on the driving situation or traffic situation or time of day or weather or user preference or historical use of the data by the user or preferences of other users or historical use of the data by other users, and data processing is designed to be a self-learning system.

7. The method according to claim 1, comprising the data to be processed and transmitted are selected according to the following method steps:
recording the vehicle and traffic situation data such as speed, navigation data, traffic volume, road geometry, road width, number of lanes, frequency of accidents, speed restrictions, general traffic reports and special situations such as construction sites.
recording further context data such as current weather, visibility, temperature, time of day, light conditions,
retrieving user preferences and historical usage behavior of the user,
determining the complexity of the traffic situation according to a complexity index of traffic data and context data,
determining the priority of transmission and provision of data from preferences of the user, historical usage behavior of the user, preferences of other users and of historical user behavior of other users,
correlating the recorded data with predetermined program sequence patterns,
outputting or temporary or permanent suppression of such prioritized data for use by the driver or passenger.

8. A device for supporting the driver of a motor vehicle by a device which can be arranged in a motor vehicle, and can be connected to a smartphone of the driver or of a passenger as an assistant, wherein the device has a display, a speech input unit, a speech output unit and a gesture sensor.

9. The device according to claim 8, comprising the device has an electronic switching circuit arranged on a printed circuit board, with a data storage device as well as a data processing device as well as Bluetooth components.

10. The device according to claim 8, comprising the device is an auxiliary device with a display arranged in a housing and with a speech input unit and a speech output unit as well as a fixing device for fixing to the dashboard or to the windshield of the motor vehicle.

11. The device according to claim 10, comprising
the housing has a circular cross-section and the following further constituents:
a disk, a ring, a printed circuit board, a loudspeaker, a housing magnet, a rear housing part, contact pins, a main magnet.

12. The device according to claim 10, comprising, for detachable fixing of the device to a holder, wherein fixing regions are arranged both on the device and also on the holder and wherein the fixing region has at least one magnet and two fixing sectors arranged in mirror inversion on the rear of the device, which sectors are provided with electrical contacts arranged in mirror inversion, and the fixing region has at least one magnet and a fixing sector with electrical contacts at the holder, wherein, in assembled state, the magnets and and the electrical contacts of the fixing sector are in contact with the electrical contacts of the fixing sector or the fixing sector, such that, depending on the contact of the fixing sector or the fixing sector to the fixing sector a positioning of the device rotated about 180° is realized.

13. The device according to claim 12, comprising the fixing sector is a semicircular recess and the fixing sector is a semicircular bar, wherein the recesses and the bar, in assembled state, correspond to one another, or the electrical energy supply, a data exchange, the transmission of radio signals and optionally further received data is realized via the electrical contact between the electrical contacts and the electrical contacts.

14. The device according to claim 12, comprising the holder has a suction cup for fixing or a USB terminal.

15. The device according to claim 10, comprising the housing has a rear housing part and a ring connected thereto with openings in its front region, wherein the display and a printed circuit board with microphones is arranged within the ring.

16. The method according to claim 2, comprising the smartphone data are telephone numbers or contact data or address data or incoming e-mails or messages or internet data or SMS messages or MMS messages or audio files or MP3 audio files or audio playlists or map data or navigation details or personal data of the driver or passenger and the received data are navigation data or traffic information or radio or TV transmissions or digital audio streams or congestion reports or WhatsApp messages or Facebook Messenger messages or weather data.

17. The method according to claim 2, comprising the speech recognition takes place either on the smartphone in the smartphone application (local speech recognition) or via the cloud interface online via a cloud-based speech recognition service (online speech recognition) or
that the speech of the user is recorded on the device via a microphone, this recording is then transmitted wirelessly to the smartphone via Bluetooth (HFP), where speech recognition takes place continuously or smartphone data are used in speech processing to improve recognition performance of the speech processing or that dialog management of the speech processing takes place locally on the smartphone, but is constantly updated via a cloud interface using a script file or that the speech processing is optimized continuously by analyzing the speech inputs which have taken place, and recognition performance is improved.

18. The method according to claim 3, comprising the speech recognition takes place either on the smartphone in the smartphone application (local speech recognition) or via the cloud interface online via a cloud-based speech recognition service (online speech recognition) or
that the speech of the user is recorded on the device via a microphone, this recording is then transmitted wirelessly to the smartphone via Bluetooth (HFP), where speech recognition takes place continuously or smartphone data are used in speech processing to improve recognition performance of the speech processing or that dialog management of the speech processing takes place locally on the smartphone, but is constantly updated via a cloud interface using a script file or that the speech processing is optimized continuously by analyzing the speech inputs which have taken place, and recognition performance is improved.

19. The method according to claim 2, comprising, in addition to the speech processing, functions of the assistant are also operated via gesture control or input devices of the vehicle, and functions of the assistant are undertaken multimodally, depending on context complementarily or redundantly.

20. The method according to claim 3, comprising, in addition to the speech processing, functions of the assistant are also operated via gesture control or input devices of the vehicle, and functions of the assistant are undertaken multimodally, depending on context complementarily or redundantly.
